(19) United States
(12) Patent Application Publication
(10) Pub. No.: US 2022/0092614 A1
(43) Pub. Date: Mar. 24, 2022

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Misako KOFUJI, Sunto Shizuoka (JP)

(21) Appl. No.: 17/367,994

(22) Filed: Jul. 6, 2021

(30) Foreign Application Priority Data
Sep. 18, 2020 (JP) 2020-157747

(51) Int. Cl. G06Q 30/02; G06Q 30/06

(52) U.S. Cl. CPC G06Q 30/0201; G06Q 30/0633

(57) ABSTRACT

According to one embodiment, an information processing apparatus includes a communication interface to receive operation history data including commodity registration operations and commodity cancellation operations for registered commodities in a customer sales transaction from a terminal apparatus that is operated by a customer. A storage unit and a controller are provided. The controller is configured to extract first recorded data from the received operation history data. The first recorded data indicates a commodity cancelled by a commodity cancellation operation. The extracted first recorded data is stored in the storage unit. The controller generates and outputs analysis information including characteristics of the commodity cancelled by the cancellation operation based on the first recorded data stored in the storage unit.

### CROSS-REFERENCE TO RELATED APPLICATION

This application is based upon and claims the benefit of priority from Japanese Patent Application No. 2020-157747, filed Sep. 18, 2020, the entire contents of which are incorporated herein by reference.

### FIELD

Embodiments described herein relate generally to an information processing apparatus and an information processing method.

### BACKGROUND

In recent years, a shopping system for stores such as a supermarket in which customers themselves perform the commodity registration process for sales transactions using a smartphone, a shopping cart-mounted commodity registration apparatus (also referred to as a cart POS) has been introduced.

In such a shopping system, every time the customer decides to purchase a particular commodity, the customer performs the commodity registration process on the spot where the purchase decision is made. Thus, the store where such a shopping system is installed can acquire various additional sales-related information as compared with the case where commodity registration and settlement is performed at a cash register or checkout counter.

For example, a technique for acquiring additional information such as the time when a price of the commodity was checked or the time when an actual purchase was decided/confirmed and then analyzing the purchase decision making behavior of customers from the number of times the price of the commodity was checked before a purchase was made has been proposed.

For a manufacturer or produces who makes the commodity, information about the customer(s) cancelling a purchase or foregoing a purchase after a price check may be useful for commodity development, quality improvement, and the like. For example, such information may indicate that There is a possibility that product quality is not considered commensurate with its average selling price. That is, by acquiring information such as the given price at time of the price check was and whether there was a sale or not and then analyzing trends and the like a manufacturer may track customer perceptions of pricing, comparative value, and the like.

However, in the conventional shopping systems in the related art, in order to determine that the customer canceled a purchase of a commodity, it is necessary to generate a customer movement flow line for the customer through the store based on a placement position of the commodity, the time when the price is checked, and the like and perform complicated processing such as analyzing the customer movement flow line, and there is room for improvement in terms of analytic convenience.

### BRIEF DESCRIPTION OF THE DRAWINGS

FIG. 1 is an explanatory diagram illustrating an example of a purchase analysis system according to an embodiment.

FIG. 2 is a perspective view illustrating an example of a cart POS.

FIG. 3 is a block diagram illustrating an example of a hardware configuration of a customer terminal.

FIG. 4 illustrates an example of a data structure for recorded data.

FIG. 5 is a block diagram illustrating an example of a functional configuration of a customer terminal.

FIG. 6 is a block diagram illustrating an example of a hardware configuration of an analysis server.

FIG. 7 illustrates an example of a data structure for cancellation information.

FIG. 8 illustrates an example of a data structure for comparison information.

FIG. 9 is a block diagram illustrating an example of a functional configuration of the analysis server.

FIGS. 10A and 10B are explanatory diagrams illustrating an example of an analysis report generated by an analysis information generation unit.

FIG. 11 is an explanatory diagram illustrating another example of an analysis report generated by an analysis information generation unit.

FIG. 12 is an explanatory diagram illustrating another example of an analysis report generated by an analysis information generation unit.

FIG. 13 is an explanatory diagram illustrating another example of an analysis report generated by the analysis information generation unit.

FIG. 14 is a block diagram illustrating an example of a hardware configuration of a producer terminal.

FIG. 15 is a block diagram illustrating an example of a functional configuration of a producer terminal.

FIG. 16 is a flowchart illustrating an example of an analysis report transmission process executed by an analysis server.

### DETAILED DESCRIPTION

Embodiments provide an information processing apparatus and an information processing method capable of more easily acquiring information about a commodity for which a customer canceled a purchase.

In general, according to one embodiment, an information processing apparatus includes a communication interface to receive operation history data including commodity registration operations and commodity cancellation operations for registered commodities in a customer sales transaction from a terminal apparatus that is operated by a customer. A storage unit and a controller are provided in the information processing apparatus. The controller is configured to extract first recorded data from the received operation history data. The first recorded data indicates a commodity cancelled by a commodity cancellation operation. The extracted first recorded data is stored in the storage unit. The controller generates and outputs analysis information including characteristics of the commodity cancelled by the cancellation operation based on the first recorded data stored in the storage unit.

Hereinafter, certain example embodiments of an information processing apparatus and an information processing method will be described with reference to the accompanying drawings. The embodiments described below do not limit the present disclosure. The information processing apparatus of the described example embodiments is one application example in which an analysis server analyzes a purchase behavior of a commodity by a customer in a store such as a supermarket.

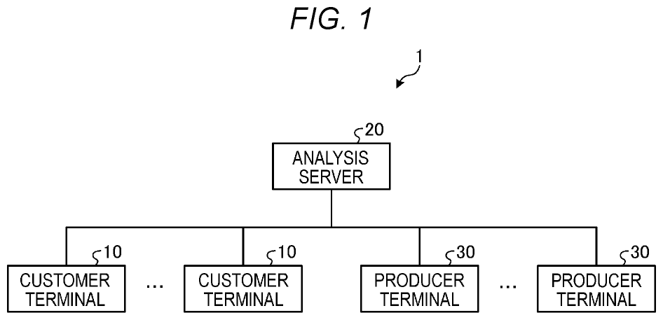

FIG. 1 is an explanatory diagram illustrating an example of a purchase analysis system 1 according to an embodiment. The purchase analysis system 1 analyzes the behavior related to the purchasing of a commodity by the customer. The purchase analysis system 1 includes a plurality of customer terminals 10, an analysis server 20, and a plurality of producer terminals 30. The plurality of customer terminals 10, the analysis server 20, and the plurality of producer terminals 30 are communicably connected to each other via a network.

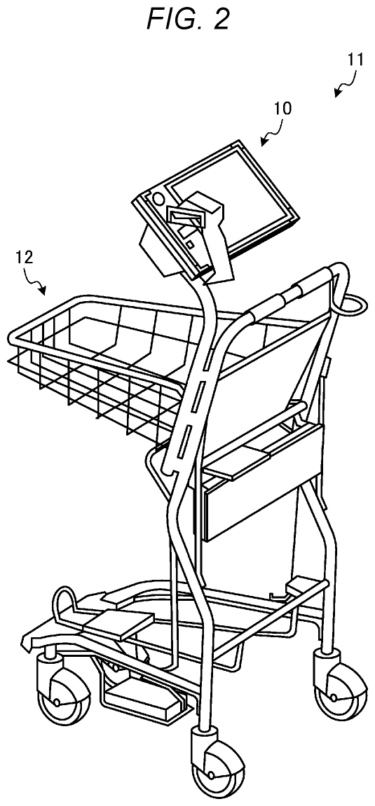

The customer terminal 10 is used by the customer at the store. For example, the customer terminal 10 is a portable terminal such as a smartphone or a tablet terminal. As illustrated in FIG. 2, the customer terminal 10 may be a terminal attached to a cart point of sales (POS) 11. The customer terminal 10 is one example of a “terminal apparatus”.

FIG. 2 is a perspective view illustrating an example of an appearance of the cart POS 11. The cart POS 11 is an apparatus in which a customer terminal 10 is attached to a shopping cart 12. The customer terminal 10 registers a commodity for sale by reading a code symbol such as a barcode attached to the commodity.

The customer terminal 10 also executes a payment process for the registered commodity. In the case of the cart POS 11 to which the customer terminal 10 is attached, the customer can collect several commodities in the shopping cart 12 while registering each commodity for purchase by causing the customer terminal 10 to read the code symbol attached to each of the commodities. In this embodiment, a customer terminal 10 that is capable of executing the payment process for registered commodities will be described as an example, but in other examples the customer terminal 10 may be configured to be capable of executing only the registration of commodity with payment processing performed at a checkout counter, kiosk, or the like.

The customer terminal 10 transmits recorded data recording an operation history of the registration operations for the commodities and the cancellation operations for any registered commodity that have been performed by a customer during one sales transaction to the analysis server 20. In this context, a sales transaction refers to a single continuous process from the start of the commodity registration process to the end of the payment process by a customer.

The analysis server 20 is an information processing apparatus that analyzes the behavior related to a purchase of the commodity by the customer. For example, the analysis server 20 is a server apparatus or a personal computer. For example, the analysis server 20 may be realized by a store server provided in the store. The analysis server 20 is not limited to one information processing apparatus, and may be composed of a plurality of server apparatuses.

The analysis server 20 receives the recorded data from the customer terminal 10. The analysis server 20 extracts cancellation information from the recorded data for any commodity for which a cancellation operation was performed and stores the cancellation information. The analysis server 20 generates an analysis report representing characteristics of the commodities that were targeted for cancellation for each type of commodity based on the cancellation information, and transmits the analysis report to the producer terminal 30.

The producer terminal 30 is used by a producer (e.g., a manufacturer) of the commodity. For example, the producer terminal 30 is a personal computer or a portable terminal such as a smartphone or a tablet terminal. The producer terminal 30 receives the analysis report from the analysis server 20. The producer may be an individual or a corporation.

The purchase analysis system 1 may include an apparatus other than the apparatuses illustrated in FIG. 1. For example, the purchase analysis system 1 may include a plurality of analysis servers 20 and may also include a management server that manages the plurality of analysis servers 20. In such a case, the management server may collectively transmit the analysis reports generated by the analysis servers 20 to the producer terminal 30.

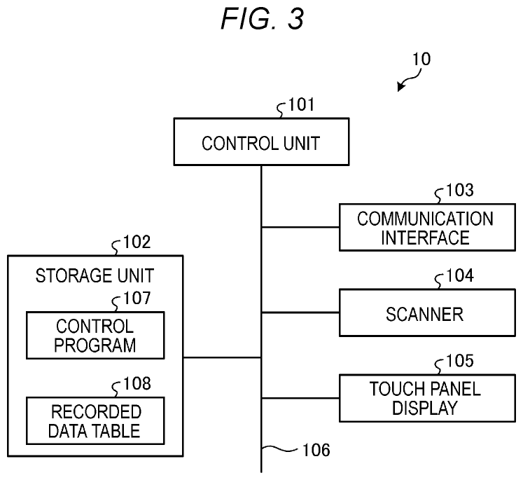

FIG. 3 is a block diagram illustrating an example of the hardware configuration of the customer terminal 10.

The customer terminal 10 includes a control unit 101, a storage unit 102, a communication interface 103, a scanner 104, and a touch panel display 105. These parts are connected to each other via a system bus 106 such as a data bus and an address bus.

The control unit 101 is a computer that controls the overall operation of the customer terminal 10 and realizes various functions possessed by the customer terminal 10. The control unit 101 includes a CPU, a ROM, and a RAM.

The CPU controls the operations of the customer terminal 10. The ROM is a storage medium for storing various programs and data. The RAM is a storage medium for temporarily storing various programs and various data. Then, the CPU executes a program stored in the ROM, the storage unit 102, or the like using the RAM as a work area.

The storage unit 102 is a storage device such as a flash memory. The storage unit 102 stores a control program 107. The control program 107 is a software program for implementing the functions of the operating system and the customer terminal 10. The control program 107 includes a program instructions for implementing described functions according to this embodiment.

The storage unit 102 stores a recorded data table 108. The recorded data table 108 stores the recorded data. Specifically, the recorded data table 108 is a table for storing recorded data including the operation history of the commodity registration and cancellation operations for the commodity registered during one transaction of a customer from the entering of the store to the payment process (closing of the transaction).

For example, the customer terminal 10 determines that the time when the customer starts the program for the commodity registration process as the time when the customer enters the store.

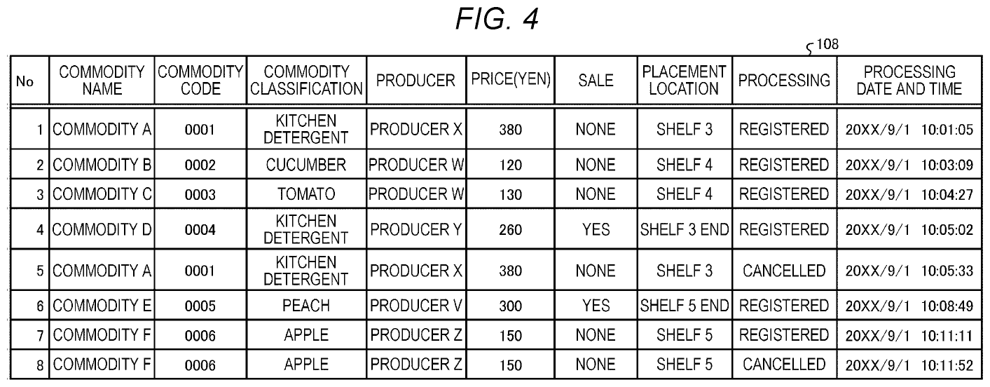

FIG. 4 is an explanatory diagram illustrating an example of the recorded data table 108 stored in the storage unit 102 of the customer terminal 10. In this example, the recorded data table 108 stores values in columns for “No,” (ID number) “commodity name,” “commodity code,” “commodity classification,” “producer,” “price,” “sale,” “placement location,” “processing,” and “processing date and time” in association with each other. The values for “No,” “commodity name,” “commodity code,” “commodity classification,” “producer,” “price,” “sale,” “placement location,” “processing,” and “processing date and time” are examples of recorded data.

The “No” value is a number for distinguishing information. The “No” column value lists a number assigned to each commodity registration process or commodity cancellation process (hereinafter referred to as a cancellation process), for example, information about the commodity registration process performed for the first time since the customer enters the store is set to 1, information about processing performed next is set to 2, and so on. The “commodity name” column is information representing the name of the commodity being registered or canceled.

The “commodity code” column lists information representing the commodity code of the commodity being registered or canceled. The “commodity classification” column lists information representing the classification of the commodity being registered or canceled. The “producer” column lists information representing the name of the producer of the commodity being registered or canceled. The “price” column lists information representing the price of the commodity when registered for purchase. The “sale” column lists information representing whether or not the commodity was on sale when registered for purchase.

The “processing” column lists information representing whether processing performed by the customer was a commodity registration process or a cancellation process. The “processing date and time” column lists information representing the date and time when the customer performed the commodity registration process or the cancellation process.

For example, in the example of FIG. 4, the recorded data table 108 records that the commodity registration process for “commodity A” of a commodity code “0001” was performed at “10:01:05 on Sep. 1, 20XX”, as No. “1”. The recorded data table 108 records that the commodity classification of the commodity A is “kitchen detergent”, the producer of the commodity A is “producer X”, the price of the commodity A is “380 yen”, the sale is “none”, and commodity A is placed on “shelf 3”.

Similarly, the recorded data table 108 records that the commodity registration process for “commodity D” of a commodity code “0004” was performed at “10:05:02 on Sep. 1, 20XX”, as No. “4”. The recorded data table 108 records that the commodity classification of the commodity D is “kitchen detergent”, the producer of the commodity D is “producer Y”, the price of the commodity D is “260 yen”, the sale is “yes”, and commodity D is placed on “shelf 3 end”.

In this context “shelf end” indicates a short side portion of a store display shelf. The short side portion of a shelf often faces a large aisle of the store, and a commodity placed on a shelf end tends to more frequently attract the attention of customers. Accordingly, there is a preference to place a commodity that the store is focusing on selling at a shelf end location.

Similarly, the recorded data table 108 records that the cancellation process for “commodity A” subjected to the commodity registration process in No. “1” was performed at “10:05:33 on Sep. 1, 20XX”, as No. “5”.

Similarly, the recorded data table 108 records that the commodity registration process for “commodity F” of a commodity code “0006” was performed at “10:11:11 on Sep. 1, 20XX”, as No. “7”. The recorded data table 108 records that the commodity classification of commodity F is “apple”, the producer of commodity F is “producer Z”, the price of commodity F is “150 yen”, the sale is “none”, and commodity F is placed on “shelf 5”.

Similarly, the recorded data table 108 records that the cancellation process for “commodity F” subjected to the commodity registration process in No. “7” was performed at “11:05:52 on Sep. 1, 20XX”, as No. “8”.

In this example embodiment, the storage unit 102 deletes data stored in the recorded data table 108 once the customer performs the payment process and transmits the recorded data stored in the recorded data table 108 to the analysis server 20. That is, in the recorded data table 108, only the recorded data for one shopping event (shopping for one sales transaction) is stored.

The communication interface 103 is an interface for communicating with another apparatus via a network. For example, the communication interface 103 is an interface for communicating with the analysis server 20.

The scanner 104 reads commodity information on the commodity to be sold. For example, the scanner 104 reads the commodity code that can identify the commodity indicated by a barcode or the like.

The touch panel display 105 is a display device including a sensor that detects an operated (touched) point on a screen.

The customer terminal 10 may include components other than those described above. For example, the customer terminal 10 may include a card reader or the like for reading a card such as a membership card.

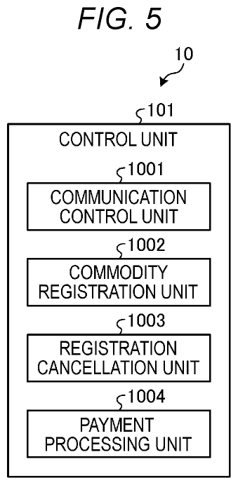

FIG. 5 is a block diagram illustrating an example of the functional configuration of the control unit 101 of the customer terminal 10.

The control unit 101 of the customer terminal 10 loads the control program 107 stored in the storage unit 102 into the RAM, and operates according to the control program. 107 to generate each functional unit in the RAM. Specifically, the control unit 101 of the customer terminal 10 includes a communication control unit 1001, a commodity registration unit 1002, a registration cancellation unit 1003, and a payment processing unit 1004 as functional units.

The communication control unit 1001 controls the communication interface 103 to execute communication with the analysis server 20. Specifically, for example, the communication control unit 1001 transmits recorded data stored in the recorded data table 108 to the analysis server 20.

The commodity registration unit 1002 executes the commodity registration process for registering the commodity to be sold. For example, if the scanner 104 reads the code symbol, the commodity registration unit 1002 acquires the commodity code by decoding the read code symbol. The commodity registration unit 1002 registers the commodity specified by the acquired commodity code.

Specifically, the commodity registration unit 1002 refers to a commodity master 210 stored in the storage unit 202 of the analysis server 20 via the communication control unit 1001, specifies the commodity corresponding to the commodity code acquired by the commodity registration unit 1002, and registers the commodity.

If the commodity registration process is executed, the commodity registration unit 1002 stores the recorded data related to the commodity registration process in the recorded data table 108. Specifically, if the commodity registration process is executed, the commodity registration unit 1002 sets the processing content to “registered”, sets the processing date and time to “date and time when the commodity registration process was performed”, and stores the processing content and processing date and time in the recorded data table 108 in association with information on the commodity corresponding to the commodity code acquired by the commodity registration unit 1002.

The commodity registration unit 1002 may register the commodity specified by an operation input, not limited to reading the commodity code.

The registration cancellation unit 1003 executes the cancellation process for the commodity registered in the commodity registration process. For example, if the customer inputs an instruction to cancel the commodity registration process via the touch panel display 105, the registration cancellation unit 1003 cancels the commodity registration process. The instruction to cancel the commodity registration process is performed, for example, by displaying a list of the registered commodity on the touch panel display 105 and touching and selecting the commodity that the customer wants to cancel.

If the cancellation process is executed, the registration cancellation unit 1003 stores recorded data related to the cancellation process in the recorded data table 108. Specifically, if the cancellation process is executed, the registration cancellation unit 1003 sets the processing content to “canceled” and sets the processing date and time to “date and time when the cancellation process was performed”, and stores the recorded data in association with the information related to the commodity whose commodity registration was canceled in the recorded data table 108.

The payment processing unit 1004 controls the payment process for the commodity subjected to commodity registration by the commodity registration unit 1002. For example, the payment processing unit 1004 calculates the total price of the commodity registered for sale by the commodity registration unit 1002. Specifically, for example, the payment processing unit 1004 refers to the recorded data table 108 and calculates the total amount of the commodity whose processing is “registered” at the point in time at which an instruction to execute the payment process is received from the customer.

Then, the payment processing unit 1004 executes the payment process using a credit card or the like. If the payment processing unit 1004 executes the payment process, the communication control unit 1001 transmits recorded data stored in the recorded data table 108 to the analysis server 20. The communication control unit 1001 deletes the recorded data stored in the recorded data table 108.

The analysis server 20 may perform a part or all of the process described above as being performed by the customer terminal 10. For example, the customer terminal 10 holds only the information associated with the “commodity code”, “processing content (registered or canceled)”, and “processing date and time” during one transaction, and the analysis server 20 may generate a recorded data table based on the information described above and manage the recorded data table.

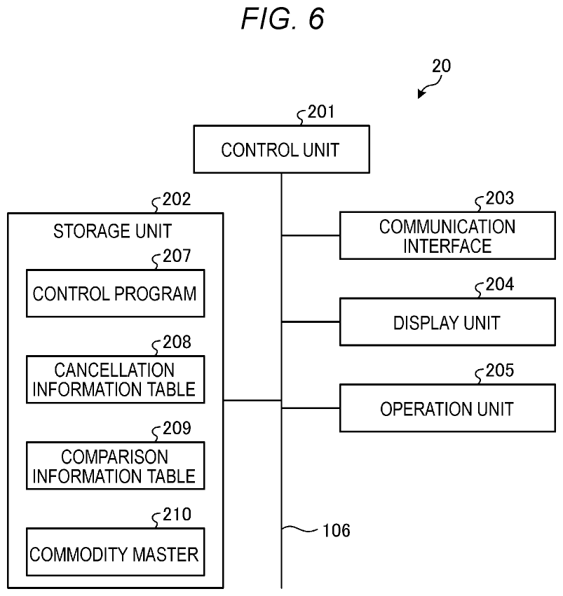

FIG. 6 is a block diagram illustrating an example of the hardware configuration of the analysis server 20.

The analysis server 20 includes a control unit 201, a storage unit 202, a communication interface 203, a display unit 204, and an operation unit 205. These parts are connected to each other via a system bus 206 such as a data bus or an address bus.

The control unit 201 is a controller that controls the overall operation of the analysis server 20 and realizes various functions provided in the analysis server 20. The control unit 201 includes a central processing unit (CPU), a read only memory (ROM), and a random access memory (RAM).

The CPU comprehensively controls the operation of the analysis server 20. The ROM is a storage medium for storing various programs and data. The RAM is a storage medium for temporarily storing various programs and various data. Then, the CPU executes the program stored in the ROM, the storage unit 202, or the like using the RAM as a work area.

The storage unit 202 is a storage device such as a hard disk drive (HDD) or a solid-state drive (SSD). The storage unit 202 stores a control program 207, a cancellation information table 208, a comparison information table 209, and the commodity master 210.

The control program 207 is a software program for implementing the functions on the operating system and the analysis server 20. The control program 207 includes program instructions that implement the described functions according to this embodiment.

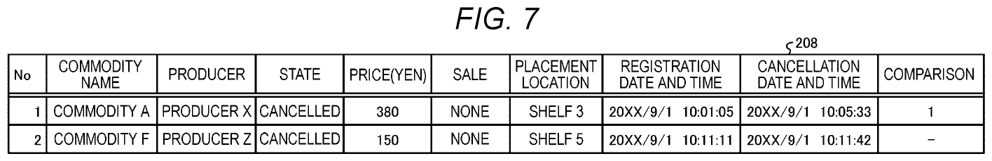

The cancellation information table 208 stores cancellation information. FIG. 7 is a table illustrating an example of a data structure for the cancellation information table 208. In this example, the cancellation information table 208 stores values for “No” (number), “commodity name,” “producer,” “state,” “price,” “sale,” “placement location,” “registration date and time,” “cancellation date and time,” and “comparison” in association with each other for the commodities for which the cancellation process was executed.

The “No” column is a number for distinguishing each instance of cancellation information. For example, cancellation information registered for the first time is numbered as No. 1 and cancellation information registered next is numbered as No. 2 so that the cancellation information can be distinguished from one another. The “commodity name” column lists information representing the name of the commodity on which the cancellation process was executed. The “producer” column lists information representing information about the producer of the commodity for which the cancellation process was executed. The “state” column lists information representing whether the cancellation process was performed.

The “price” column lists information representing the price of the commodity at the point in time at which the commodity registration process for the commodity related to the cancellation process was executed. The “sale” column lists information representing whether the commodity was on sale at the point in time at which the commodity registration process for the commodity related to the cancellation process was executed. The “placement location” column is information representing the placement location in the store for the commodity related to the cancellation process.

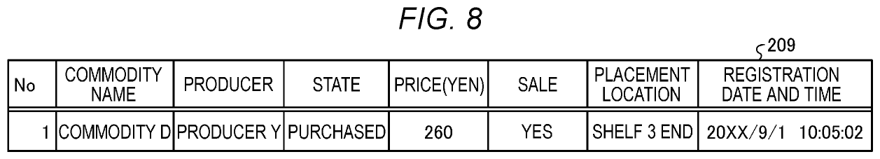

The “registration date and time” column lists information representing the date and time when the registration process for the commodity related to the cancellation process was performed. The “cancellation date and time” column lists information representing the date and time when the cancellation process for the commodity was executed. The “comparison” column lists information representing an association with comparison information stored in the comparison information table 209 (see FIG. 8). Specifically, if comparison information is present in the comparison information table 209, information representing the particular “No” value (e.g., an ID number or the like) of the targeted comparison information is registered in the table 209.

In the example of FIG. 7, the cancellation information table 208 stores that the commodity registration process for “commodity A” was performed at “10:01:05 on Sep. 1, 20XX” and the cancellation process was performed at “10:05:33 on Sep. 1, 20XX”, as No. “1”.

The cancellation information table 208 stores that the producer of commodity A related to the cancellation process is “producer X”, commodity A is placed on “shelf 3”, and the price of the commodity A is “380 yen” and the sale is “none” at the point in time at which the commodity registration process for commodity A was executed. Furthermore, the cancellation information table 208 stores that information on the commodity targeted for comparison with commodity A exists in the No. “1” row of the comparison information table 209.

Similarly, the cancellation information table 208 stores that the commodity registration process for “commodity F” was performed at “10:11:11 on Sep. 1, 20XX” and the cancellation process was performed at “10:11:42 on Sep. 1, 20XX”, as No. “2”.

The cancellation information table 208 stores that the producer of commodity F related to the cancellation process is “producer Z”, commodity F is placed on “shelf 5”, and the price of commodity F is “150 yen” and the sale is “none” at the point in time at which the commodity registration process for commodity F was executed. Furthermore, the cancellation information table 208 stores that information on the commodity targeted for comparison with commodity F does not exist in the comparison information table 209.

The comparison information table 209 is an information table that stores comparison information recording registration operations for other commodities of the same or similar classification as the classification of the commodity related to the cancellation information. FIG. 8 is a table illustrating an example of a data structure of the comparison information table 209. In this example, the comparison information table 209 stores values for columns “No,” “commodity name,” “producer,” “state,” “price,” “sale,” “placement location,” and “registration date and time” in association with each other for a commodity targeted for comparison with the commodity on which the cancellation process was executed.

The “No” column lists a number for distinguishing each comparison information. For example, comparison information registered for the first time is numbered as No. 1 and comparison information registered next is numbered as No. 2 so that the different instances of comparison information can be distinguished from each other. The “commodity name” column lists information representing the name of the commodity targeted for comparison. The “producer” column lists information representing information about the producer of the commodity targeted for comparison. The “state” column lists information representing whether the commodity was purchased or not.

The “price” column lists information representing the price of the commodity at the point in time at which the commodity registration process for the commodity targeted for comparison was executed. The “sale” column lists information representing whether or not the commodity targeted for comparison was on sale at the point in time at which the commodity registration process for the commodity targeted for comparison was executed. The “placement location” column lists information representing the placement location within the store for the commodity targeted for comparison. The “registration date and time” column lists information representing the date and time when the commodity registration process for the commodity targeted for comparison was performed.

In the example of FIG. 8, the comparison information table 209 stores that the commodity registration process for “commodity D” targeted for comparison was performed at “10:05:02 on Sep. 1, 20XX”, as No. “1”.

The comparison information table 209 stores that the producer of commodity D targeted for comparison is “producer Y”, commodity D is on “shelf 3 end”, the price of the commodity D is “260 yen,” and the sale is “yes” at the point in time at which the commodity registration process for commodity D was executed. If the cancellation information table 208 of FIG. 7 is associated with the comparison information table 209 of FIG. 8, “commodity D” is a commodity targeted for comparison with “commodity A” on which the cancellation process was executed.

The commodity master 210 stores various information about the commodity. The commodity master 210 stores values for the commodity code, the commodity name, the commodity classification, the producer, the price, sale information, placement information, and the like in correlation with each other. The customer terminal 10 refers to the commodity master 210 in the analysis server 20 via the communication control unit 1001, acquires information corresponding to the commodity code that was read by the scanner 104, and executes the commodity registration process and a process of storing information in the recording data table 108.

A communication interface 203 is an interface for communicating with other apparatuses via a network. For example, the communication interface 203 is an interface for communicating with the customer terminal 10 and the producer terminal 30.

The display unit 204 is a display device such as a liquid crystal display. The operation unit 205 is an input device such as a keyboard or a mouse.

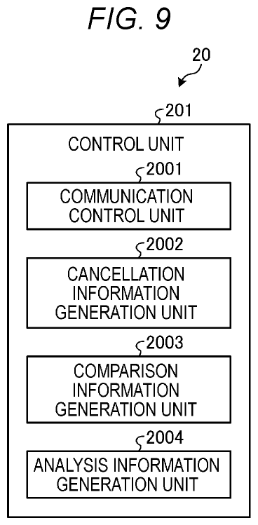

FIG. 9 is a block diagram illustrating an example of the functional configuration of the control unit 201 of the analysis server 20.

The control unit 201 of the analysis server 20 loads the control program 207 stored in the storage unit 202 into the RAM, and operates according to the control program 207 to generate each functional unit in the RAM. Specifically, the control unit 201 of the analysis server 20 includes a communication control unit 2001, a cancellation information generation unit 2002, a comparison information generation unit 2003, and analysis information generation unit 2004 as functional units.

The communication control unit 2001 controls the communication interface 203 to execute communication with the customer terminal 10 and the producer terminal 30. For example, the communication control unit 2001 receives recorded data from the customer terminal 10. Accordingly, the communication control unit 2001 can be said to be an example of a “receiving unit”.

For example, the communication control unit 2001 transmits an analysis report to the producer terminal 30. Since transmission is a form of “output”, the communication control unit 2001 can be said to be an example of an “output control unit”.

The cancellation information generation unit 2002 extracts cancellation information from the recorded data received by the communication control unit 2001. The cancellation information is an example of “first recorded data”.

Specifically, if the recorded data received by the communication control unit 2001 includes information in which the processing is “canceled”, the cancellation information generation unit 2002 extracts information about the commodity for which the cancellation operation was performed from the recorded data received by the communication control unit 2001. The cancellation information generation unit 2002 generates cancellation information based on the extracted information.

More specifically, the cancellation information generation unit 2002 extracts the “commodity name”, “producer”, “price”, “sale”, “placement location”, “registration date and time”, and “cancellation date and time” from the recorded data. The cancellation information generation unit 2002 sets the state to “canceled” and generates cancellation information in association with the extracted information. The cancellation information generation unit 2002 stores the generated cancellation information in the cancellation information table 208.

For example, consider the case where the communication control unit 2001 receives recorded data stored in the recorded data table 108 of FIG. 4. In this case, since processing for No. “5” in the recorded data table 108 is set to “canceled”, the cancellation information generation unit 2002 extracts information about the commodity corresponding to No. “5” and generates cancellation information based on the extracted information.

Specifically, the cancellation information generation unit 2002 first extracts “commodity A”, “producer X”, “380 yen”, “none”, “shelf 3”, and “10:05:33 on Sep. 1, 20XX” associated with No. “5” from the recorded data. Next, the cancellation information generation unit 2002 extracts “10:01:05 on Sep. 1, 20XX” (processing date and time of No. “1”), which is the date and time when the commodity registration process for commodity A to be canceled from the recorded data was executed.

Then, the cancellation information generation unit 2002 generates cancellation information by associating the extracted information indicating the state “canceled”. The cancellation information generation unit 2002, for example, assigns No. “1” to the generated cancellation information and stores the generated cancellation information in the cancellation information table 208 of FIG. 7 as cancellation information. Since processing for No. “8” in the recorded data table 108 is also set to “canceled”, the cancellation information generation unit 2002 performs the same processing as described above.

The cancellation information generation unit 2002 may use information about the commodity for which the cancellation operation was performed extracted from the recorded data as the cancellation information as it is. That is, the cancellation information generation unit 2002 can be said to be an example of an “extraction unit”.

If comparison information is included in the recorded data received by the communication control unit 2001, the comparison information generation unit 2003 extracts the comparison information. The comparison information is an example of “second recorded data”.

Specifically, the comparison information generation unit 2003 refers to the recorded data received by the communication control unit 2001, and checks the “commodity classification” for the commodity for which processing is set to “canceled”.

Next, if a commodity of the same “commodity classification” as a commodity listed as “canceled” is present among the commodities listed as “registered” and the cancellation process has not since been executed, the comparison information generation unit 2003 extracts information that records the registration operation for the commodity. The comparison information generation unit 2003 generates comparison information based on the extracted information.

More specifically, the comparison information generation unit 2003 extracts the values for “commodity name”, “producer”, “price”, “sale”, “placement location”, and “registration date and time” from recorded data. The comparison information generation unit 2003 sets the state to “purchased” and generates comparison information in association with the extracted information.

The comparison information generation unit 2003 stores the generated comparison information in the comparison information table 209. The comparison information generation unit 2003 registers the “No” value (ID value) of the comparison information targeted for comparison in the item of comparison of the cancellation information which is a comparison source of the cancellation information table 208.

For example, consider the case where the communication control unit 2001 receives recorded data stored in the recorded data table 108 of FIG. 4. In this case, the comparison information generation unit 2003 checks that the “commodity classification” of No. “5” for which processing is set to “canceled” is “kitchen detergent”. Subsequently, the comparison information generation unit 2003 checks whether or not recorded data whose “commodity classification” is also “kitchen detergent” is present among the commodities for which processing is set to “registered” and the cancellation process has not been executed since then.

Since the “commodity classification” of the commodity related to processing of No. “4” is “kitchen detergent”, the comparison information generation unit 2003 extracts information about the commodity corresponding to No. “4” and generates comparison information from the extracted information.

Specifically, the comparison information generation unit 2003 extracts “commodity D”, “producer Y”, “260 yen”, “yes”, and “shelf 3 end”, and “10:05:02 on Sep. 1, 20XX” associated with No. “4” from recorded data. Then, the comparison information generation unit 2003 generates comparison information by associating the extracted information with the state “purchased”.

For example, the comparison information generation unit 2003 assigns No. “1” to the generated comparison information and stores the generated comparison information in the comparison information table 209 of FIG. 8. The comparison information generation unit 2003 registers “1”, which is No. value (ID value) of comparison information in the comparison information table 209 targeted for comparison in the item of comparison of cancellation information of No. “1” in the cancellation information table 208 of FIG. 7, which is the comparison source. With this configuration, the information in cancellation information table 208 and the comparison information table 209 are associated with each other.

Although processing for No. “8” in the recorded data table 108 is also set to “canceled”, since a commodity, whose “commodity classification” is “apple”, other than “commodity F” is not present in the recorded data, the comparison information generation unit 2003 does not generate comparison information.

The comparison information generation unit 2003 may use the information that records the registration operation for other commodities of the same classification as the classification of the commodity related to the cancellation information extracted from the recorded data as the comparison information as it is. That is, the comparison information generation unit 2003 can be said to be an example of the “extraction unit”.

In the example described above, the comparison information generation unit 2003 extracts comparison information that records the registration operation for other commodities of the same classification as the classification of the commodity related to the cancellation information, but may generate comparison information that records the registration operation for other commodities of the similar classification as well as the same classification. Whether or not the classifications are similar can be determined by whether or not similar group codes match, for example, by pre-associating the similar group codes with one another for identifying similar commodity classification groups to “commodity classification” and the like.

The analysis information generation unit 2004 generates an analysis report representing the characteristics of the commodity targeted for the cancellation operation for each type of commodity based on the cancellation information stored in the cancellation information table 208. The analysis information generation unit 2004 generates the analysis report based on the cancellation information and the comparison information in a correspondence relationship, in a comparable state. The analysis report is an example of “analysis information”.

Specifically, the analysis information generation unit 2004 generates an analysis report if an instruction to output the analysis report is issued from the control unit 201 of the analysis server 20. The instruction to output the analysis report may be automatically issued at a predetermined timing by the control unit 201, or may be issued by the control unit 201 at the timing when the input of the output instruction is received from an operator of the analysis server 20 and the input of the output instruction is received.

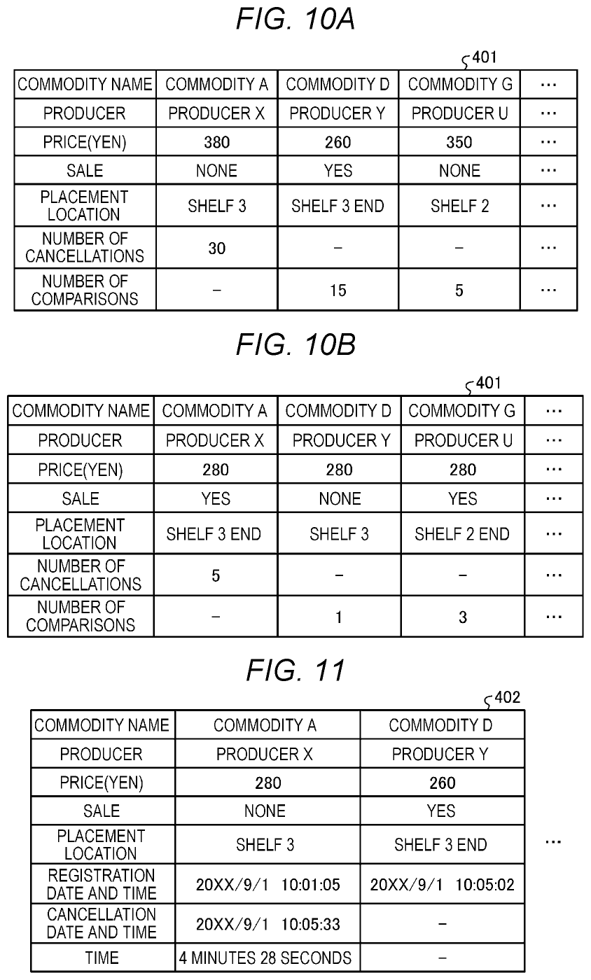

The analysis information generation unit 2004 generates a statistical report and a detailed report as the analysis reports. Here, FIGS. 10A to 13 are explanatory diagrams illustrating examples of analysis reports generated by the analysis information generation unit 2004.

FIGS. 10A and 10B are examples of a statistical report 401 for producer X. The statistical report 401 is a report that reports the total number of cancellations and comparisons of commodities in some predetermined period (in this example, one month). The statistical report 401 is generated for each different price of commodities at the time of canceling of the commodity registration.

For example, the statistical report 401 of FIG. 10A represents that the commodity registration process was canceled “30 times” in one month when “commodity A” placed on “shelf 3” was sold for “380 yen” with “none” on sale.

The statistical report 401 represents that the producer of “commodity D” targeted for comparison with “commodity A” is “producer Y”, and when the commodity registration process for commodity D was executed, “commodity D” was placed on “shelf 3 end”, was sold for “260 yen” with “yes” on sale, and was compared with “commodity A” “15 times” in one month.

The statistical report 401 represents that the producer of “commodity G” targeted for comparison with “commodity A” is “producer U”, and when the commodity registration process for “commodity G” was executed, “commodity G” was placed on “shelf 2”, was sold for “350 yen” with “none” on sale, and was compared with “commodity A” “5 times” in one month.

The statistical report 401 of FIG. 10B represents that the commodity registration process was canceled “5 times” in one month when “commodity A” placed on “shelf 3 end” was sold for “280 yen” with “yes” on sale.

The statistical report 401 represents that the producer of “commodity D” targeted for comparison with “commodity A” is “producer Y”, and when the commodity registration process for “commodity D” was executed, “commodity D” was placed on “shelf 3”, was sold for “280 yen” with “none” on sale, and was compared with “commodity A” “once” in one month.

The statistical report 401 represents that the producer of “commodity G” targeted for comparison with “commodity A” is “producer U”, and when the commodity registration process for “commodity G” was executed, “commodity G” was placed on “shelf 2 end”, was sold for “280 yen” with “yes” on sale, and was compared with “commodity A” “3 times” in one month.

For example, even if the commodity targeted for comparison with “commodity A” is the same “commodity D”, if the price and the like are different, the analysis information generation unit 2004 generates the statistical report 401 as an analysis report for a different comparison target.

By checking the statistical report 401, the producer can know how many times the producer's commodity was canceled from the commodity registration in a predetermined period, and what kind of the commodity the customer compares and/or substitutes with the producer's commodity. By knowing the selling price and the like of a competing commodity, the producer can use the selling price and the like for the development of new products and the improvement of the quality of the current products.

FIG. 11 is an example of a detailed report 402 for producer X. The detailed report 402 is a report summarizing information about the cancellation process for the commodity by a customer during one shopping event. The detailed report 402 in FIG. 11 represents that when a “commodity A” placed on “shelf 3” was sold for “280 yen” with “none” on sale, “commodity A” was compared with “commodity D” placed on “shelf 3 end” and sold for “260 yen” with “yes” on sale.

The detailed report 402 in this example represents that the commodity registration process was executed for “commodity A” at “10:01:05 on Sep. 1, 20XX”, and the cancellation process was executed for “commodity A” at “10:05:33 on Sep. 1, 20XX”.

The detailed report 402 represents that the commodity registration process was executed for “commodity D” at “10:05:02 on Sep. 1, 20XX”. The detailed report 402 described above represents that the time from when the commodity registration process for “commodity A” is executed to when the cancellation process is executed is “4 minutes 28 seconds”.

By knowing the time when the cancellation process of his or her own commodity was executed and the time when the commodity registration process of the competing commodity was executed, the producer can grasp whether the customer canceled the purchase of the commodity immediately after deciding to purchase the competing commodity, or whether the customer canceled the purchase of the commodity after a while.

For example, if there are many cases where a customer decided to purchase a competing commodity and immediately canceled the purchase of the commodity even though the price of the competing commodity is in the same price range, the producer may realize the need to completely review the perceived quality of his or her own commodity. Conversely, for example, if the price of the competing commodity is in the same price range and the purchase of the commodity is canceled after a while, the producer will understand that the quality of his or her own commodity is not perceived to eb significantly inferior to that of competing commodity.

The detailed report 402 may include information other than that information described above. For example, the detailed report 402 may include customer demographic information such as the age and residential area of the customer. Information such as the age and residential area of the customer can be stored in the storage unit 102 in association with, for example, a membership program number (customer loyalty program identification number). In this case, the analysis server 20 causes, the customer terminal 10 to read the membership card in which the membership number is recorded, and acquires customer's information associated with the membership number from the read result.

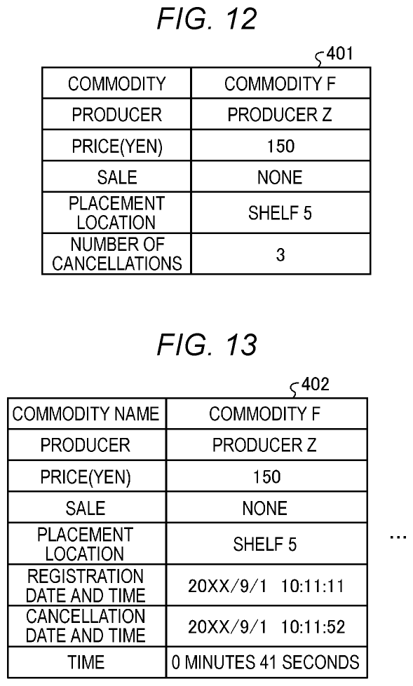

FIG. 12 is an example of the statistical report 401 for producer Z. For example, the statistical report 401 in FIG. 12 represents that the commodity registration process was canceled “3 times” in one month when “commodity F” placed on “shelf 5” was sold for “150 yen” with “none” on sale. The statistical report 401 described above represents that there was no commodity targeted for comparison with “commodity F” in one month.

If there is no commodity in the same commodity classification as the canceled commodity in the recorded data, the analysis information generation unit 2004 generates the statistical report 401 including only the cancellation information.

FIG. 13 is an example of the detailed report 402 for producer Z. The detailed report 402 in FIG. 13 represents that the commodity registration process was executed for “commodity F” at “10:11:11 on Sep. 1, 20XX”, and the cancellation process was executed for “commodity F” at “10:11:52 on Sep. 1, 20XX”. The detailed report 402 represents that the time from when the commodity registration process of “commodity F” is executed to when the cancellation process is executed is “0 minutes 41 seconds”.

As in the example described above, if there is no competing commodity and the cancellation process is executed immediately after the commodity registration process is executed, the producer can guess that the customer simply mistakenly registered the commodity. On the other hand, if there are many situations where the cancellation process is executed after a while even though there is no competing commodity, the producer is likely to consider that there may be some kind of problem with the quality of his or her commodity.

The statistical report 401 and the detailed report 402 generated by the analysis information generation unit 2004 are transmitted to the producer terminal 30 by the communication control unit 2001. The statistical report 401 and the detailed report 402 generated by the analysis information generation unit 2004 are assumed to include producer identification information for identifying the producer. The communication control unit 2001 specifies a producer to be a destination of an analysis report from the producer identification information, and transmits the analysis report to the producer terminal 30 of the producer.

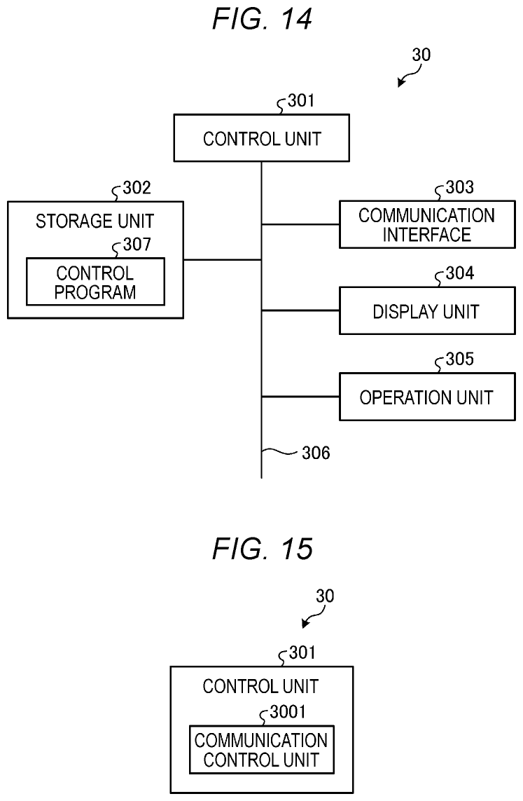

FIG. 14 is a block diagram illustrating an example of the hardware configuration of the producer terminal 30. The producer terminal 30 includes a control unit 301, a storage unit 302, and a communication interface 303. These parts are connected to each other via a system bus 306 such as a data bus or an address bus.

The control unit 301 is a computer that controls the overall operation of the producer terminal 30 and realizes various functions possessed by the producer terminal 30. The control unit 301 includes a CPU, a ROM, and a RAM. The CPU comprehensively controls the operation of the producer terminal 30.

The ROM is a storage medium for storing various programs and data. The RAM is a storage medium for temporarily storing various programs and various data. Then, the CPU executes the program stored in the ROM, the storage unit 302, or the like using the RAM as a work area.

The storage unit 302 is a storage device such as a flash memory. The storage unit 302 stores a control program 307. The control program 307 is a program for implementing the functions provided in the operating system and the producer terminal 30. The control program 307 includes a program that implements a characteristic function according to this embodiment. The storage unit 302 stores the producer identification information for identifying the producer.

The communication interface 303 is an interface for communicating with another apparatus via a network. For example, the communication interface 303 is an interface for communicating with the analysis server 20. The display unit 304 is a display device such as a liquid crystal display. The operation unit 305 is an input device such as a keyboard or a mouse.

FIG. 15 is a block diagram illustrating an example of the functional configuration of the control unit 301 of the producer terminal 30.

The control unit 301 of the producer terminal 30 loads the control program 307 stored in the storage unit 302 into the RAM, and operates according to the control program. 307 to generate each functional unit in the RAM. Specifically, the control unit 301 of the producer terminal 30 includes a communication control unit 3001 as a functional unit.

The communication control unit 3001 controls the communication interface 303 to execute communication with the analysis server 20.

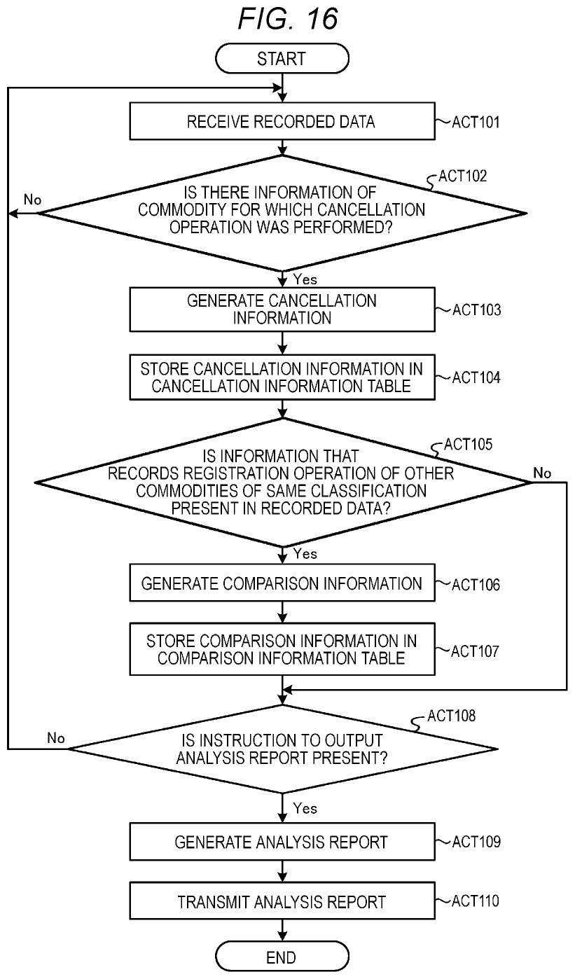

Next, a process executed by the analysis server 20 will be described. FIG. 16 is a flowchart illustrating an example of an analysis report transmission process of the analysis server 20.

First, the communication control unit 2001 receives recorded data from the customer terminal 10 (ACT 101). The cancellation information generation unit 2002 checks whether or not the recorded data received by the communication control unit 2001 includes information about a commodity on which the cancellation operation was performed (ACT 102). If there is no commodity that was cancelled from the registration process (No in ACT 102), the process returns to ACT 101.

If there is a commodity that was cancelled included in the received recorded data (Yes in ACT 102), the cancellation information generation unit 2002 extracts information about the commodity on which the cancellation operation was performed and generates cancellation information (ACT 103). The cancellation information generation unit 2002 stores the generated cancellation information in the cancellation information table 208 (ACT 104).

The comparison information generation unit 2003 then checks whether or not another one of the commodities that were registered is of the same classification as the classification of the canceled commodity r in the received recorded data (ACT 105). If other commodities of the same classification are not present (No in ACT 105), the process proceeds to ACT 108.

If other commodities of the same classification are present (Yes in ACT 105), the comparison information generation unit 2003 extracts the information for these other commodities of the same classification as the canceled commodity, and generates comparison information (ACT 106).

The comparison information generation unit 2003 stores the generated comparison information in the comparison information table 209 (ACT 107). The comparison information generation unit 2003 also associates the cancellation information table 208 with the comparison information table 209.

The analysis information generation unit 2004 checks whether or not an instruction to output an analysis report is present (ACT 108). If an instruction to output the analysis report is not present (No in ACT 108), the process returns to ACT 101. If an instruction to output the analysis report is present (Yes in ACT 108), the analysis information generation unit 2004 generates an analysis report (ACT 109).

The communication control unit 2001 transmits the analysis report generated by the analysis information generation unit 2004 to the producer terminal 30 (ACT 110), and ends this process.

Next, the effects of the analysis server 20 according to this embodiment will be described. The analysis server 20 includes the communication control unit 2001 that receives recorded data recording the operation history of the registration operations for the commodity and the cancellation operations for the registered commodity performed by the customer during the same transaction from the customer terminal 10, the cancellation information generation unit 2002 that extracts the cancellation information about the commodity for which the cancellation operation was performed from the recorded data received by the communication control unit 2001, the cancellation information table 208 that stores the cancellation information generated by the cancellation information generation unit 2002, and the analysis information generation unit 2004 that generates the analysis report representing the characteristics of the commodities targeted for the cancellation operation for each type of commodity based on the cancellation information. The communication control unit 2001 transmits the analysis report generated by the analysis information generation unit 2004 to the producer terminal 30.

The recorded data records the operation history of the registration operations for the commodities and the cancellation operations for the registered commodities performed by a customer during one transaction, and the cancellation information generation unit 2002 extracts the cancellation information from the recorded data. The analysis information generation unit 2004 generates the analysis report based on the cancellation information.

Accordingly, since the analysis report transmitted by the communication control unit 2001 to the producer terminal 30 includes information representing the characteristics of the canceled commodities for each type of commodity, the producer can thus easily acquire the information about the commodities targeted for cancellation. That is, according to the analysis server 20 of this embodiment, it is possible to easily acquire information about a commodity for which a customer canceled the purchase.

The analysis server 20 includes the comparison information generation unit 2003 that extracts the comparison information if the comparison information recording the registration operation for other commodities of the same or similar classification as the classification of the commodity related to the cancellation information is included in the recorded data. The comparison information generation unit 2003 stores the generated comparison information in the comparison information table 209. The comparison information generation unit 2003 associates the cancellation information table 208 with the comparison information table 209.

Then, the analysis information generation unit 2004 generates the analysis report based on the cancellation information and the comparison information in a correspondence relationship, in a comparable state.

With this configuration, the producer of the commodity can know what kind of the commodities the canceled commodity was compared with. By acquiring the information about the comparative commodities, the producer can use the acquired information for the development of new products and the improvement of the quality of the current products.

The analysis report generated by the analysis information generation unit 2004 includes information indicating the number of times the cancellation operation performed within a predetermined period on a per commodity item basis. With this configuration, the producer of a commodity can know how many purchases of his or her own commodity were canceled. For example, if the purchase was canceled many times, the producer can investigate the customer-perceived quality of his or her own commodity.

The analysis report generated by the analysis information generation unit 2004 includes information indicating the number of comparisons with the commodity for which the cancellation operation was performed within a predetermined period on a per commodity, which is targeted for comparison, item basis.

With this configuration, the producer can know how many times his or her own commodity appears to have been substituted by another commodity. For example, if it is possible to know which commodity or commodities a customer compared with a producer's commodity, it is the producer may find improvements for his or her commodity.

The analysis report generated by the analysis information generation unit 2004 includes the time when the cancellation operation was performed and the time when the registration operation for the comparable commodity was performed.

With this configuration, the producer can guess or assume reason for the cancellation process, such as whether the cancellation process was executed because the customer mistakenly executed the commodity registration process, whether the cancellation process was executed because the customer decided after some consideration to purchase the competing commodity, and the like.

In an embodiment described above, the analysis report generated by the analysis information generation unit 2004 is transmitted to the producer terminal 30. However, this transmission is one form of “output”, and the output method is not limited to transmission. For example, the analysis server 20 may be provided with a “print control unit” as an “output control unit” to print the analysis report generated by the analysis information generation unit 2004. In this case, the printed analysis report could be mailed to the producer or the like.

Such a form of printing the analysis report is particularly useful if a user wants to deliver the analysis report to a producer who is not good at computers or who lives in a place where the communication environment is not good.

A configuration in which the program executed by each apparatus of the embodiment described above is provided by being recorded on a computer-readable recording medium such as a CD-ROM, flexible disk (FD), CD-R, or digital versatile disk (DVD) as a file in an installable or executable format may be adopted.

A configuration in which the program executed by each apparatus of the embodiment described above is provided by being stored on a computer connected to a network such as the Internet and downloaded via the network may be adopted. A configuration in which the program executed by the apparatus of the embodiment described above is provided or distributed via a network such as the Internet may be adopted.

Each function of each apparatus of the embodiments described above can be realized by one or a plurality of processing circuits. Here, the processing circuit conceptually includes hardware such as a processor (CPU and the like), an application specific integrated circuit (ASIC) designed to realize each function, and a circuit module.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a communication interface configured to receive operation history data including commodity registration operations and commodity cancellation operations for registered commodities in a customer sales transaction from a terminal apparatus operated by a customer;
a storage unit; and
a controller configured to:
extract first recorded data from the received operation history data, the first recorded data indicating a commodity cancelled by a commodity cancellation operation;
store the extracted first recorded data in the storage unit;
generate analysis information including characteristics of the commodity cancelled by the cancellation operation based on the first recorded data stored in the storage unit; and
output the generated analysis information.

2. The information processing apparatus according to claim 1, wherein the controller is further configured to:
extract second recorded data from the operation history data indicating a comparable commodity of the same or similar classification as the cancelled commodity in first recorded data is included in the received operation history data,
store, in the storage unit, the extracted second recorded data in association with the first recorded data, and
generate the analysis information based on the first recorded data and the corresponding second recorded data.

3. The information processing apparatus according to claim 2, wherein the analysis information includes information indicating the number of times the commodity cancellation operation was performed for each commodity within a predetermined period.

4. The information processing apparatus according to claim 3, wherein the analysis information includes information indicating the number of comparable commodities for which the commodity cancellation operation was performed within the predetermined period.

5. The information processing apparatus according to claim 2, wherein the analysis information includes a time at which the commodity cancellation operation was performed and a time at which a commodity registration operation for a comparable commodity was performed.

6. An information processing method, comprising:
receiving, via a communication interface, operation history data including commodity registration operations and commodity cancellation operations for registered commodities in a customer sales transaction from a terminal apparatus operated by a customer sales transaction;
extracting first recorded data from the received operation history data, the first recorded data indicating a commodity cancelled by a commodity cancellation operation;
storing the extracted first recorded data in a storage unit;
generating analysis information including characteristics of the commodity cancelled by the cancellation operation based on the first recorded data stored in the storage unit; and
outputting the generated analysis information.

7. The method according to claim 6, further comprising:
extracting second recorded data from the operation history data indicating another commodity of the same or similar classification as the cancelled commodity in first recorded data is included in the received operation history data,
storing, in the storage unit, the extracted second recorded data in association with the first recorded data, and
generating the analysis information based on the first recorded data and the corresponding second recorded data.

8. The method according to claim 7, wherein the analysis information includes information indicating the number of times the commodity cancellation operation was performed for each commodity within a predetermined period.

9. The method according to claim 8, wherein the analysis information includes information indicating the number of comparable commodities for which the commodity cancellation operation was performed within the predetermined period.

10. The method according to claim 7, wherein the analysis information includes a time at which the commodity cancellation operation was performed and a time at which a commodity registration operation for a comparable commodity was performed.

11. An automated retail product sales transaction analysis system, comprising:
a plurality of customer terminals configured to collect operation history data for a sales transaction of a customer, the operation history including information indicating commodities registered in the sales transaction and the commodities cancelled from the sales transaction;
a provider terminal; and
an analysis server including:
a communication interface configured to receive the operation history data from the plurality of customer terminals;
a storage unit; and
a controller configured to:
extract first recorded data from the received operation history data, the first recorded data indicating a commodity cancelled by a commodity cancellation operation;
store the extracted first recorded data in the storage unit;
generate analysis information including characteristics of the commodity cancelled by the cancellation operation based on the first recorded data stored in the storage unit; and
output the generated analysis information via the communication interface to the provider terminal.

12. The system according to claim 11, wherein the controller is further configured to:
extract second recorded data from the operation history data indicating a comparable commodity of the same or similar classification as the cancelled commodity in first recorded data is included in the received operation history data,
store, in the storage unit, the extracted second recorded data in association with the first recorded data, and
generate the analysis information based on the first recorded data and the corresponding second recorded data.

13. The system according to claim 12, wherein the analysis information includes information indicating the number of times the commodity cancellation operation was performed for each commodity within a predetermined period.

14. The system according to claim 13, wherein the analysis information includes information indicating the number of comparable commodities for which the commodity cancellation operation was performed within the predetermined period.

15. The system according to claim 12, wherein the analysis information includes a time at which the commodity cancellation operation was performed and a time at which a commodity registration operation for a comparable commodity was performed.
